(19) United States
(12) Patent Application Publication
(10) Pub. No.: US 2009/0172120 A1
(43) Pub. Date: Jul. 2, 2009

(54) MANAGING PARTICIPANTS IN AN INSTANT MESSAGING MEETING

(75) Inventor: Gabriel Ruelas, Jalisco (MX)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, NY (US)

(21) Appl. No.: 12/164,061

(22) Filed: Jun. 29, 2008

(30) Foreign Application Priority Data
Dec. 5, 2007 (CA) 2613692

(51) Int. Cl. G06F 15/16; G06F 17/30

(52) U.S. Cl. 709/206; 707/10

(57) ABSTRACT

There is disclosed a system and method for managing participants in an instant messaging meeting. In an embodiment, the method comprises: scheduling an instant messaging meeting in a calendar module; communicating information about the scheduled instant messaging meeting to an instant messaging module including information necessary to contact confirmed participants; and at a specified time, signalling the instant messaging module to automatically start the instant messaging meeting by initiating contact with the confirmed participants. In an embodiment, the method further comprises defining an instant messaging meeting group containing the information necessary to contact the confirmed participants. The method may further comprise linking the instant messaging meeting group to its corresponding scheduled event in the calendar module.

### BACKGROUND OF THE INVENTION

1. Field of the Invention

The present invention relates generally to an improved data processing system, and in particular, to a computer implemented method for managing communications in a data processing system. Still more particularly, the present invention relates to a computer implemented method, system, and computer usable program code for managing participants in an instant messaging meeting.

2. Description of the Related Art

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

Instant Messaging (IM) technologies are now available which allow two or more participants to hold online meetings in which the participants may communicate with each other via text messages virtually in real-time. However, a limitation of presently available IM technologies is that it is necessary to set up the IM session by manually adding meeting participants to a “buddies” list at the beginning of a meeting. For more than a few participants, this manual setup may be cumbersome and time consuming. An improved system and method for managing participants in an IM meeting is needed.

### SUMMARY OF THE INVENTION

This present invention addresses the limitations of prior art IM solutions by providing a system and method by which a user's IM application may automatically define an IM meeting group and initiate an IM meeting at a scheduled time.

In an aspect, there is provided a data processing system implemented method of managing participants in an instant messaging meeting, comprising: scheduling an instant messaging meeting in a calendar module; communicating information about the scheduled instant messaging meeting to an instant messaging module including information necessary to contact confirmed participants; and at a specified time, signalling the instant messaging module to automatically start the instant messaging meeting by initiating contact with the confirmed participants.

In an embodiment, the method further comprises defining an instant messaging meeting group containing the information necessary to contact the confirmed participants.

In another embodiment, the method further comprises linking the instant messaging meeting group to its corresponding scheduled event in the calendar module.

In another embodiment, the method further comprises deleting the instant messaging meeting group at the end of the instant messaging meeting.

In another embodiment, the method further comprises providing the user with means to mark the instant messaging meeting group as a persistent instant messaging meeting group.

In another embodiment, the method further comprises sharing the persistent instant messaging meeting group with an address book module of an email application.

In another embodiment, the method further comprises sending out invitations from the calendar module to invited contacts to confirm participation and to identify the confirmed participants.

In another aspect, there is provided a data processing system having data processing means and memory means for managing participants in an instant messaging meeting, comprising: means for scheduling an instant messaging meeting in a calendar module; means for communicating information about the scheduled instant messaging meeting to an instant messaging module including information necessary to contact confirmed participants; and means for signalling the instant messaging module at a specified time to automatically start the instant messaging meeting by initiating contact with the confirmed participants.

In an embodiment, the system further comprises means for defining an instant messaging meeting group containing the information necessary to contact the confirmed participants.

In another embodiment, the system further comprises means for linking the instant messaging meeting group to its corresponding scheduled event in the calendar module.

In another embodiment, the system further comprises means for deleting the instant messaging meeting group at the end of the instant messaging meeting.

In another embodiment, the system further comprises means for providing the user with means to mark the instant messaging meeting group as a persistent instant messaging meeting group.

In another embodiment, the system further comprises means for sharing the permanent instant messaging meeting group with an address book module of an email application.

In another embodiment, the system further comprises means for sending out invitations from the calendar module to invited contacts to confirm participation and to identify the confirmed participants.

In another aspect, there is provided a data processor readable medium for storing data processor code that when loaded into a data processing device adapts the device to execute a method of managing participants in an instant messaging meeting, the data processor readable medium comprising: code for scheduling an instant messaging meeting in a calendar module; code for communicating information about the scheduled instant messaging meeting to an instant messaging module including information necessary to contact confirmed participants; and code signalling the instant messaging module at a specified time to automatically start the instant messaging meeting by initiating contact with the confirmed participants.

In an embodiment, the data processor readable medium further comprises code for defining an instant messaging meeting group containing the information necessary to contact the confirmed participants.

In another embodiment, the data processor readable medium further comprises code for linking the instant messaging meeting group to its corresponding scheduled event in the calendar module.

In another embodiment, the data processor readable medium further comprises code for deleting the instant messaging meeting group at the end of the instant messaging meeting.

In another embodiment, the data processor readable medium further comprises code for providing the user with means to mark the instant messaging meeting group as a persistent instant messaging meeting group.

In another embodiment, the data processor readable medium further comprises code for sharing the persistent instant messaging meeting group with an address book module of an email application.

In another embodiment, the data processor readable medium further comprises code for sending out invitations from the calendar module to invited contacts to confirm participation and to identify the confirmed participants.

These and other aspects of the invention will become apparent from the following more particular descriptions of exemplary embodiments.

### BRIEF DESCRIPTION OF THE DRAWINGS

In the figures which illustrate exemplary embodiments of the invention:

FIG. 1 shows a generic data processing system that may provide a suitable operating environment;

FIG. 2 shows a schematic block diagram of a system in accordance with an embodiment;

FIG. 3 shows an illustrative user interface screen in accordance with an embodiment;

FIG. 4 shows another illustrative user interface screen in accordance with an embodiment;

FIG. 5 shows another illustrative user interface screen in accordance with another embodiment; and

FIG. 6 shows a schematic flowchart of a method in accordance with an embodiment.

### DETAILED DESCRIPTION OF THE PREFERRED EMBODIMENT

The illustrative embodiments relate to a system and method for managing participants in an instant messaging or IM meeting.

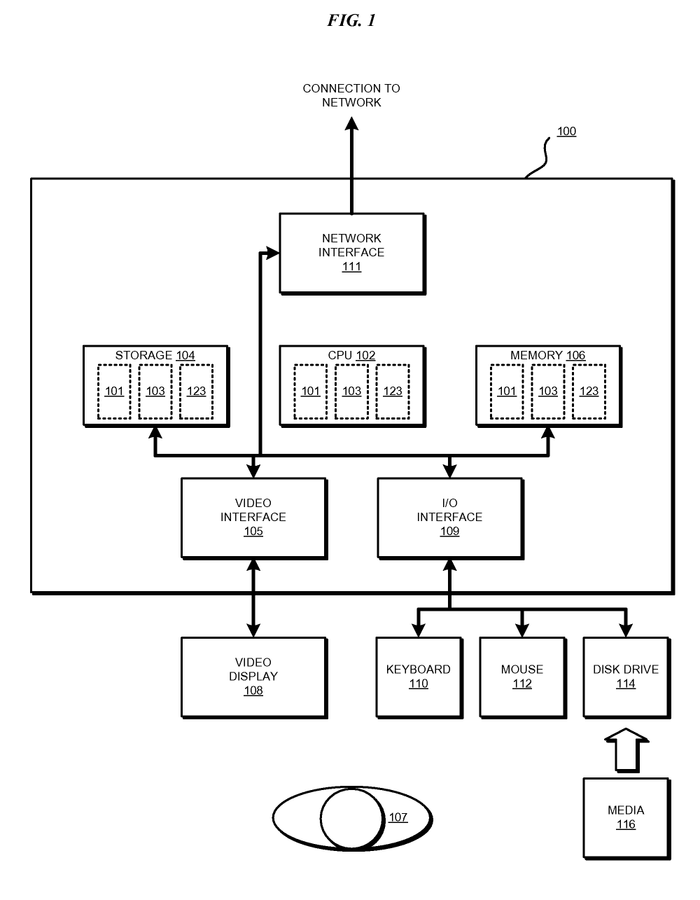

A suitably configured data processing system, and associated communications networks, devices, software and firmware may provide a platform for enabling one or more embodiments. By way of example, FIG. 1 shows generic data processing system 100 may include central processing unit (“CPU”) 102 connected to a storage unit 104 and to a random access memory 106. CPU 102 may process operating system 101, application program 103, and data 123. Operating system 101, application program 103, and data 123 may be stored in storage unit 104 and loaded into memory 106, as may be required. Operator 107 may interact with data processing system 100 using video display 108 connected by video interface 105, and various input/output devices such as keyboard 110, mouse 112, and disk drive 114 connected by I/O interface 109. In known manner, mouse 112 may be configured to control movement of a cursor in video display 108, and to operate various graphical user interface (GUI) controls appearing in video display 108 with a mouse button. Disk drive 114 may be configured to accept data processing system readable media 116. Data processing system 100 may form part of a network via network interface 111, allowing data processing system 100 to communicate with other suitably configured data processing systems (not shown). The particular configurations shown by way of example in this specification are not meant to be limiting.

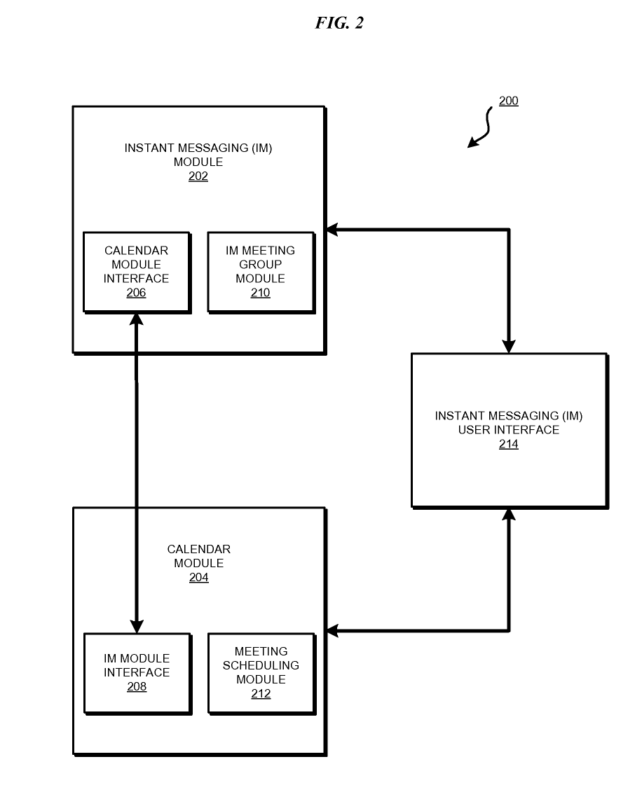

Now referring to FIG. 2, shown is a block diagram of an illustrative system in accordance with an embodiment. As shown, system 200 includes instant messaging or IM module 202, and calendar module 204. IM module 202 includes a calendar module interface 206, and calendar module 204 includes corresponding IM module interface 208. Calendar module interface 206 in IM module 202 allows IM module 202 to connect to calendar module 204 in order to retrieve information for setting up an IM meeting, as will be explained in more detail below.

Still referring to FIG. 2, IM module 202 may also include IM meeting group module 210 configured to define an IM meeting group. In an embodiment, an IM meeting group may be defined by retrieving participant information from meeting scheduling module 212 provided in calendar module 204. More particularly, calendar module 204 may include a meeting scheduling module 212 configured to schedule a meeting for two or more participants. IM module 202 may further include IM user interface 214, which will be described in more detail further below. When scheduling a meeting in calendar module 204, the person scheduling the meeting may indicate that the type of meeting is to be an instant messaging or IM meeting. So flagged, the scheduled IM meeting event in calendar module 204 may be used to automatically initiate an IM meeting session as further described below.

In an embodiment, using a meeting scheduling module 212 in calendar module 204, an IM meeting event may be scheduled at a particular date and time. Upon scheduling an IM meeting, a meeting invitation may be sent out by meeting scheduling module 212 to all contacts who have been invited to participate in the IM meeting. The meeting invitation may include a meeting title, and optionally include other text, hyperlinks or attachments such that the meeting invitation is more informative and meaningful to the invitees. Meeting scheduling module 212 may also be configured to await and receive an indication of whether or not invitations have been accepted, and those contacts that have accepted may be added to a list of confirmed meeting participants.

In an embodiment, IM meeting group module 210 in IM module 202 may be operatively integrated with calendar module 204 such that, for any meetings scheduled in calendar module 204 for which the type of meeting is to be an IM meeting, IM meeting group module 210 may retrieve the necessary information for the listed participants from calendar module 204. This may include, for example, retrieving IM addresses for each of the confirmed IM meeting participants that accepted the invitation sent out by meeting scheduling module 212.

In an embodiment, IM meeting group module 210 may organize the retrieved IM addresses for each confirmed participant into an IM meeting group defined by IM module 202 for the scheduled IM meeting. The IM meeting group may then be linked back to the IM meeting event scheduled in calendar module 204 with an appropriate reference link, such that any IM meeting events associated with the defined IM meeting group may be identified from the IM meeting group and traced back to the appropriate calendar module scheduled event. For example, in an embodiment, IM user interface 214 may be configured such that after an IM meeting group have been created in IM module 202, the user can roll over the IM meeting group name such that the details of the associated scheduled event in calendar module 204 may be displayed. The detail may include, for example, the meeting title, time, location and host number.

Once the necessary information for each participant has been retrieved by IM module 202 and an IM meeting group has been formed, the IM module 202 may open IM user interface 214 at the scheduled IM meeting time. With all of the necessary information on the meeting participants contained in the defined IM meeting group, IM module 202 may then set up the IM session in IM user interface 214 by automatically initiating calls to the listed participants as further described below. Upon receiving the call to initiate an IM session, the receiver may accept or decline the call to begin the IM session. In this manner, rather than having to manually add each participant to an IM meeting group, the calls may be placed automatically at the scheduled IM meeting time.

In an embodiment, calendar module 204 may be configured such that the signal to IM module 202 to initiate the IM meeting may be set to begin at a specified time before the actual meeting time (e.g. 5 or 10 minutes prior to the scheduled meeting time). This may serve as meeting reminder as well as allow all participants to be connected so that the IM meeting may begin right at the scheduled time.

If IM module 202 is not able to connect a confirmed participant at the scheduled time, IM module 202 may be configured to periodically retry the connection for a specified period of time, or for a specified number of connection attempts. If for any reason a confirmed participant is still not connected after the specified period of time or the specified number of connection attempts, IM module 202 may display an appropriate message to the other IM meeting participants that the participant appears to be unavailable.

In another embodiment, the calendar module may be configured to provide a warning to the IM meeting participants (e.g. as an IM message from the “System”) that the scheduled time for the IM meeting is about to expire. While the participants may continue the IM meeting if they wish this automatic reminder 5 or 10 minutes prior to the end of the scheduled time may facilitate an orderly wrap up so that the IM meeting can end on time.

In an embodiment, when a scheduled IM meeting expires, calendar module 204 may be configured to notify the IM meeting participants via IM module 202 that the scheduled time has expired. However, the IM meeting may continue if some or all of the participants wish to continue the IM session. Once all participants have left the IM meeting, calendar module 204 may be configured to notify the IM module that the IM meeting group definition may be deleted.

In an embodiment, the IM meeting group defined by the IM meeting group module may be saved within IM module 202 for reuse at a later time. For example, if the IM meetings are to recur on a regular basis, such as weekly or monthly, the meetings may be scheduled in calendar module 204 as recurring events and the IM meeting group formed temporarily for the IM meeting may be marked as a persistent IM meeting group that is not deleted at the end of the scheduled calendar event, and is instead stored within IM module 202 and linked to the corresponding scheduled events in calendar module 204. The stored IM meeting group may then be used to initiate the IM calls at subsequently scheduled IM meeting times.

Thus, by integrating IM module 202 with a calendar module 204 to schedule an IM meeting, IM module 202 may retrieve and use contact information for confirmed participants contained in calendar module 204 to automatically set up an IM meeting session at the scheduled time.

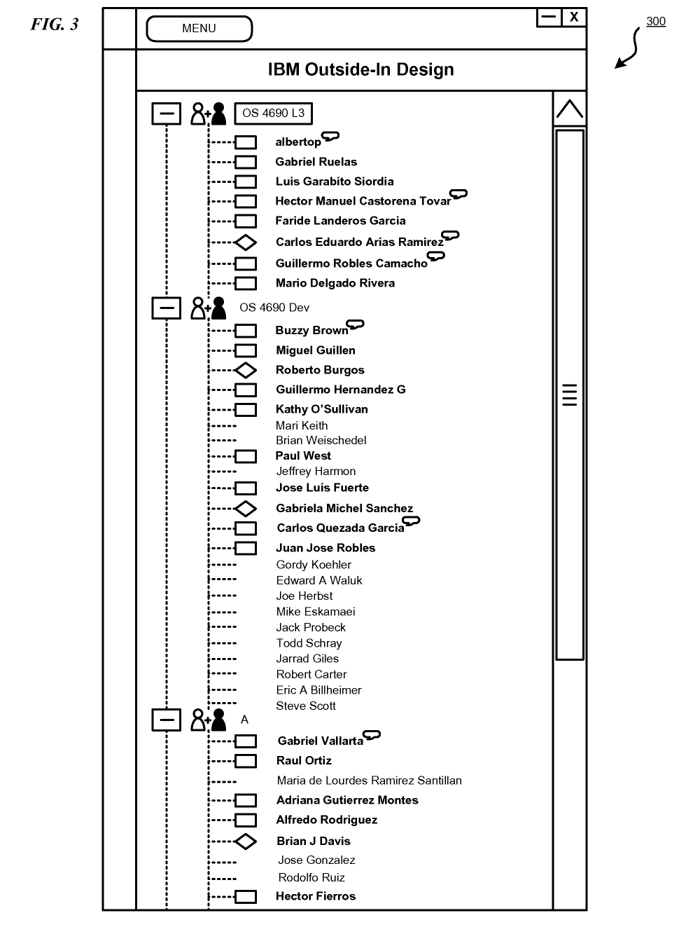

Now referring to FIG. 3, shown is an illustrative IM meeting screen 300 in which there are a number of IM meetings in progress, but currently no calendar event based IM meeting occurring.

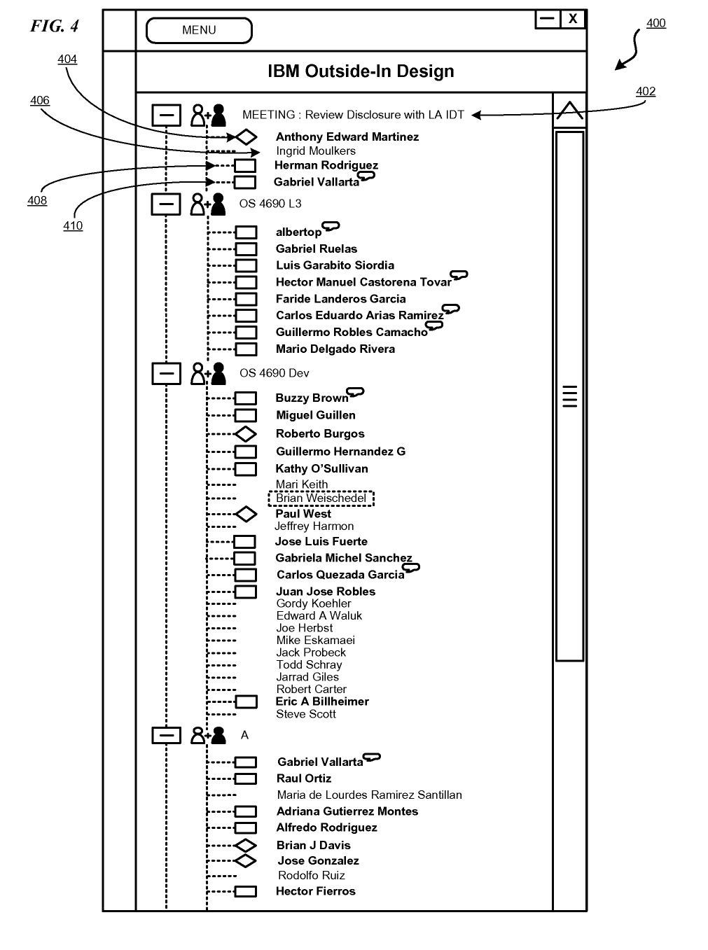

In comparison, FIG. 4 shows an illustrative IM meeting screen 400 in which a calendar event based IM meeting 402 entitled “Meeting: Review Disclosure with LA IDT” has started. In this illustrative example, the “Meeting” prefix identifies this IM meeting as a calendar event based IM meeting. As shown, IM meeting 402 includes a number of participants 404-410 who have been contacted by IM module 202 as described above, and who have joined into the IM meeting. Once some or all participants have joined, the IM meeting may progress in the same manner as any other multi-user IM session. In this illustrative embodiment, a square icon preceding the names of participants 408 and 410 indicates that these participants are connected to the IM meeting and are available to chat. A diamond icon preceding the name of participant 404 indicates that this participant is connected to the IM meeting but is not currently available to chat. Finally, no icon preceding the name of participant 406 indicates that this participant is currently not connected to the IM meeting. These icons are illustrative only, and it will be appreciated that various other types of status icons may be used to indicate the status of connection and availability to chat.

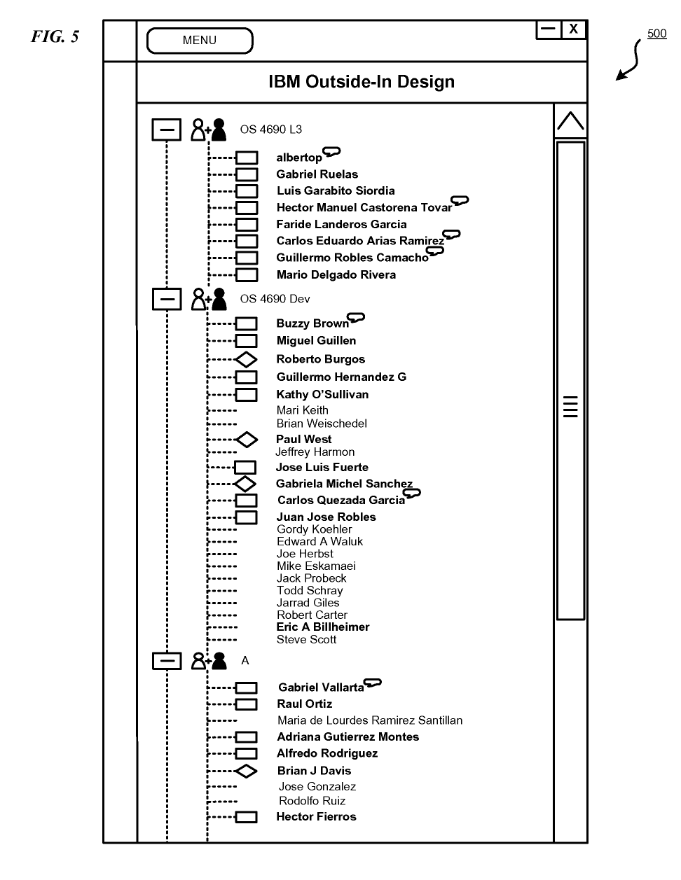

After the scheduled IM meeting has concluded according to the calendar module, or after all of the IM meeting participants have manually disconnected, FIG. 5 shows IM meeting screen 500 where the calendar event based IM meeting has now ended.

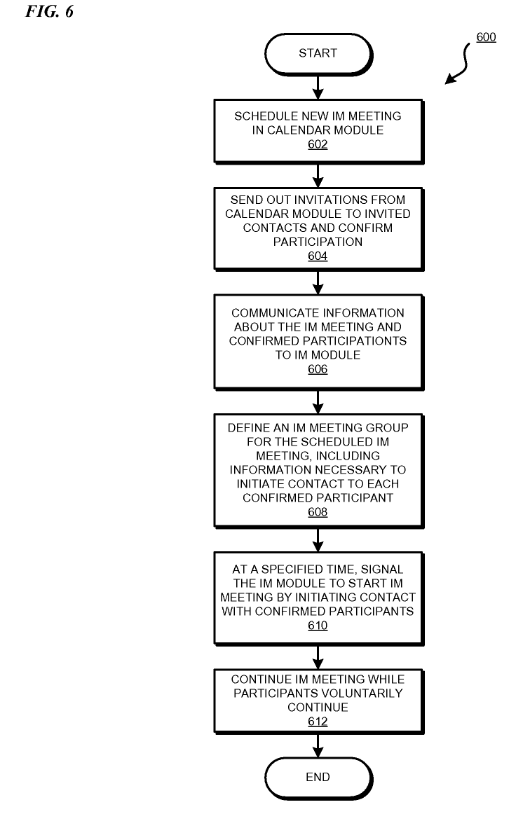

Now referring to FIG. 6, shown is a schematic flowchart of an illustrative method corresponding to the description above. As shown in FIG. 6, method 600 begins and executes block 602, where a user schedules a new IM meeting in a calendar module.

Method 600 may execute block 604, where the calendar module may send out meeting invitations to the invited contacts, and confirm whether or not an invited contact will participate.

Method 600 may execute block 606, where prior to the scheduled IM meeting the calendar module may communicate information about the IM meeting and the confirmed participants to the IM module.

Method 600 may execute block 608, where the IM module may define an IM meeting group for the scheduled IM meeting. The IM meeting group definition may include information necessary for the IM module to initiate contact to each of the confirmed IM meeting participants.

In an embodiment, the IM meeting group may be temporary, such that the IM meeting group is deleted after the IM meeting. However, if the IM meeting group is defined to be persistent, the IM meeting group may then persist after the end of the IM meeting to be used again in the future.

Method 600 may execute block 610, where at the scheduled time the calendar module may send a signal to the IM module to start an IM meeting by initiating contact with each of the confirmed participants.

Method 600 may execute block 612, where the IM meeting may continue as long as at least one of the participants is still connected to the meeting. This allows for reconnection after an accidental drop-off, and also allows for late joiners to connect with only one other participant still connected. Thus, the IM meeting may end before the scheduled time expires, or the IM meeting may continue past the scheduled time as long as the participants voluntarily continue the IM meeting. Method 600 then ends.

In another embodiment, IM module 202 may be configured to share information about the persistent IM meeting groups with other applications, such as email applications and address book modules, so that the contact information contained in the IM meeting group definition may be added to the email address book. This IM meeting group information may then be used by these other applications for various purposes other than for IM meetings.

In another embodiment, in addition to showing an IM icon for each of the participants, IM user interface 214 may also show the location, and time zone information for each participant. This may be useful, for example, in order to easily identify that an IM participant is from a particular office or different time zone.

While various illustrative embodiments have been described above, it will be appreciated by those skilled in the art that variations and modifications may be made within the scope of the illustrative embodiments. Thus, the scope of the illustrative embodiments is defined by the following claims.

What is claimed is:

1. A data processing system implemented method of managing participants in an instant messaging meeting, comprising:
scheduling an instant messaging meeting in a calendar module;
communicating information about the scheduled instant messaging meeting to an instant messaging module including information necessary to contact confirmed participants; and
at a specified time, signalling the instant messaging module to automatically start the instant messaging meeting by initiating contact with the confirmed participants.

2. The method of claim 1, further comprising defining an instant messaging meeting group containing the information necessary to contact the confirmed participants.

3. The method of claim 2, further comprising linking the instant messaging meeting group to its corresponding scheduled event in the calendar module.

4. The method of claim 2, further comprising deleting the instant messaging meeting group at the end of the instant messaging meeting.

5. The method of claim 2, further comprising providing the user with means to mark the instant messaging meeting group as a persistent instant messaging meeting group.

6. The method of claim 5, further comprising sharing the persistent instant messaging meeting group with an address book module of an email application.

7. The method of claim 1, further comprising sending out invitations from the calendar module to invited contacts to confirm participation and to identify the confirmed participants.

8. A data processing system having data processing means and memory means for managing participants in an instant messaging meeting, comprising:
means for scheduling an instant messaging meeting in a calendar module;
means for communicating information about the scheduled instant messaging meeting to an instant messaging module including information necessary to contact confirmed participants; and
means for signalling the instant messaging module at a specified time to automatically start the instant messaging meeting by initiating contact with the confirmed participants.

9. The system of claim 8, further comprising means for defining an instant messaging meeting group containing the information necessary to contact the confirmed participants.

10. The system of claim 9, further comprising means for linking the instant messaging meeting group to its corresponding scheduled event in the calendar module.

11. The system of claim 9, further comprising means for deleting the instant messaging meeting group at the end of the instant messaging meeting.

12. The system of claim 9, further comprising means for providing the user with means to mark the instant messaging meeting group as a persistent instant messaging meeting group.

13. The system of claim 12, further comprising means for sharing the persistent instant messaging meeting group with an address book module of an email application.

14. The system of claim 8, further comprising means for sending out invitations from the calendar module to invited contacts to confirm participation and to identify the confirmed participants.

15. A data processor readable medium for storing data processor code that when loaded into a data processing device adapts the device to execute a method of managing participants in an instant messaging meeting, comprising:
code for scheduling an instant messaging meeting in a calendar module;
code for communicating information about the scheduled instant messaging meeting to an instant messaging module including information necessary to contact confirmed participants; and
code signalling the instant messaging module at a specified time to automatically start the instant messaging meeting by initiating contact with the confirmed participants.

16. The data processor readable medium of claim 15, further comprising code for defining an instant messaging meeting group containing the information necessary to contact the confirmed participants.

17. The data processor readable medium of claim 16, further comprising code for linking the instant messaging meeting group to its corresponding scheduled event in the calendar module.

18. The data processor readable medium of claim 16, further comprising code for deleting the instant messaging meeting group at the end of the instant messaging meeting.

19. The data processor readable medium of claim 16, further comprising code for providing the user with means to mark the instant messaging meeting group as a persistent instant messaging meeting group.

20. The data processor readable medium of claim 19, further comprising code for sharing the persistent instant messaging meeting group with an address book module of an email application.

21. The data processor readable medium of claim 15, further comprising code for sending out invitations from the calendar module to invited contacts to confirm participation and to identify the confirmed participants.
